(19) United States
(12) Patent Application Publication
(10) Pub. No.: US 2024/0293899 A1
(43) Pub. Date: Sep. 5, 2024

(54) CLAMPING PLATES FOR BATTERY MANUFACTURE

(71) Applicant: JAGUAR LAND ROVER LIMITED, Whitley, Coventry, Warwickshire (GB)

(72) Inventors: Joel DEVINE, Coventry, Warwickshire (GB); Jose ARANCIBIA, Coventry, Warwickshire (GB)

(21) Appl. No.: 18/548,051

(22) PCT Filed: Mar. 3, 2022
(86) PCT No.: PCT/EP2022/055479

§ 371 Date: Aug. 25, 2023

(30) Foreign Application Priority Data
Mar. 4, 2021 (GB) 2103057.2

(51) Int. Cl. B23K 37/04; H01M 50/516

(52) U.S. Cl. CPC B23K 37/0443; H01M 50/516

(57) ABSTRACT

A clamping apparatus for use in a laser welding system comprises a support part having a clamping face, and clamping elements extending from the clamping face. The clamping apparatus comprises spring elements that are each mounted on a respective spring element. Each of the clamping elements is arranged to provide a compressive force to a respective connection tab of a busbar assembly when a compressive force is applied to the support part, to press each respective connection tab onto a corresponding terminal of an electrical cell of a cell array. Each spring element is configured to compress when the compressive force is applied to the support part and when the corresponding clamping element mounted on the spring element contacts the respective connection tab to be laser welded.

### TECHNICAL FIELD

The present invention relates generally to clamping plates for use in battery manufacture. In particular, but not exclusively, the invention relates to clamping plates for use in vehicle traction battery manufacture, for example during a welding process. Aspects of the invention relate to clamping apparatus, methods of laser welding, and control systems.

### BACKGROUND

There has recently been increased interest in providing battery-powered vehicles, which has led to developments in vehicle batteries, in particular vehicle traction battery technology. It is generally desirable for vehicle batteries to provide high energy capacity and peak current output, whilst minimising the size and weight of the battery module and thus the vehicle.

Vehicle traction batteries often comprise one or more modules each containing a plurality of cells. It is generally desirable to package the cells into a battery module densely, so as to maximise the energy and current capacity that can be provided within a given packaging volume. Electrical connections between cells are typically provided by a busbar assembly.

It is desirable to provide manufacturing processes that are highly repeatable and that avoid faulty electrical connections. A single battery module may typically comprise a large number of electrical connections between electrical cells and the busbar assembly, and any faulty connections may, in a worst case scenario, lead to the entire module malfunctioning, potentially requiring an entire module failing quality control and having to be reworked where possible or otherwise scrapped. Thus it is important to manufacture vehicle batteries, including forming electrical connections, in a way which is robust, repeatable, and mitigates against faulty connection formation.

It is an object of embodiments disclosed herein to at least mitigate one or more of the problems of the prior art.

### SUMMARY

According to an aspect of this disclosure, there is provided a clamping apparatus for use in a laser welding system to provide compressive force to a plurality of connection tabs of a busbar assembly and press each connection tab of the plurality of connection tabs onto a corresponding terminal of an electrical cell of a cell array, the clamping apparatus comprising:
a support part having a clamping face; and
a plurality of clamping elements supported on the support part and extending from the clamping face;
wherein each of the plurality of clamping elements is arranged to provide a compressive force, wherein each of the plurality of clamping elements comprises a peripheral outer wall and a central space configured to allow the passage of laser light therethrough to perform the laser welding.

Each of the plurality of clamping elements may be arranged to provide a compressive force to a respective connection tab of a busbar assembly, to press the respective connection tab onto a corresponding terminal of an electrical cell of a cell array, during one or more of:
aligning the busbar assembly with the cell array;
pre-clamping the busbar assembly with the cell array;
during measuring processes to ascertain the distance from laser head to welding location; and
during the laser welding.

Each clamping element may comprise a mounting end configured to mount on the support part; and a contact end configured to engage a connection tab to be laser welded; wherein the mounting end is larger than the contact end.

Each clamping element may have a truncated conical shape; or a truncated pyramidal shape. A conical shaped clamping element may have a right circular cone shape, i.e. is symmetric about a central axis normal to the cone base. The conical shape may be a truncated cone.

Each clamping element may comprise an opening through the peripheral outer wall, the opening configured to allow a flow of gas between the central space and outside the clamping element

Each clamping element may comprise:
a contact end configured to be located on a connection tab to be laser welded; wherein the contact end is castellated to provide:
a plurality of contact protrusions configured to contact the connection tab to be laser welded and allow for the application of pressure to the connection tab; and
a plurality of openings configured to allow a flow of gas between the central space and outside the clamping element.

Each clamping element may have an angle between the mounting end plane and the outer wall of between 90° and 70°. In some examples the angle may be between 85° and 80°. For example, the angle may be around 78.5°. Each clamping element may have an internal dimension across the mounting end through a central point of the mounting end face of between 10 mm and 15 mm. For example, such an internal dimension may be between 12 mm and 13 mm. For example, such an internal dimension may be around 12.5 mm. Each clamping element may have an internal dimension across the contact end through a central point of contact end face of between 5 mm and 9 mm. For example, such an internal dimension may be between 6 mm and 8 mm. For example, such an internal dimension may be around 7.5 mm. The distance between the mounting end and the contact end of each clamping element may be between 14 mm and 21 mm. For example, the distance may be between 17 mm and 18 mm.

The support part may comprise a plurality of gas channels. Each clamping element may be configured to receive a gas supplied into the central space via at least one corresponding gas channel of the plurality of gas channels of the support part. Each clamping element may be configured to receive gas supplied into the central space via a plurality of dedicated arc shaped gas channels of the support part arranged around the mounting end of the clamping element.

The peripheral outer wall of each clamping element may be mounted at a respective mounting portion of the clamping face of the support part. Each mounting portion may extend inwardly beyond the peripheral outer portion of the clamping element to form a mounting portion rim, and the at least one corresponding gas channel may be located through the mounting portion rim.

The contact end of each clamping element may comprise six contact protrusions and six openings alternately arranged around the contact end.

The support part may comprise a supply channel connected to the plurality of gas channels, the supply channel configured to allow the supply of gas to each of the central spaces of the clamping elements. In an example the supply of gas can be supplied from a single gas source.

Each clamping element may be mounted at the clamping face of the support part via a corresponding spring element. The spring elements may be configured to compress as the clamping apparatus is positioned to cause the clamping elements to provide the compressive forces. In some examples, such spring elements may press the respective connection tabs of a busbar assembly into corresponding terminals for laser welding the connection tabs to the terminals.

Each clamping element may be rotatably mounted to allow for rotation of the clamping element about a rotation axis substantially normal to the clamping face. For example, each clamping element may be rotatably mounted in the support part. For example, each clamping element may be rotatably mounted at the clamping face of the support part.

The clamping apparatus may comprise between 20 and 100 clamping elements. Optionally the clamping apparatus may comprise between 40 and 80 clamping elements; for example, there may be 60 clamping elements.

Each clamping element may be formed of an insulating material. Such material may be electrically insulating. Preferably, the insulating material is ceramic or plastic. Each clamping element may be a three-dimensional printed clamping element. For example, each clamping element may be a 3D printed plastic clamping element.

In a further aspect there is provided a method of laser welding a busbar assembly to a plurality of electrical cells, the method comprising:
locating the busbar assembly comprising a plurality of connection tabs on a welding face of the cell array, wherein each of the plurality of connection tabs is located on a corresponding terminal of a corresponding electrical cell;
using any clamping apparatus disclosed herein to provide, via the plurality of clamping elements, a compressive force to each connection tab and press the connection tab onto the corresponding terminal; and
laser welding each connection tab to the corresponding terminal during the application of pressure by the clamping apparatus.

The method may comprise providing an inert gas in the central space of each of the clamping elements during the laser welding. Preferably the inert supply gas is argon.

In a further aspect there is provided a control system comprising one or more controllers, the control system configured to control a laser welding system to perform a welding process to laser weld a busbar assembly to a cell array comprising a plurality of electrical cells, by:
locating the busbar assembly comprising a plurality of connection tabs on a welding face of the cell array, wherein each of the plurality of connection tabs is located on a corresponding terminal of a corresponding electrical cell;
using any clamping apparatus disclosed herein to provide, via the plurality of clamping elements, a compressive force to each connection tab and press the connection tab onto the corresponding terminal; and
laser welding each connection tab to the corresponding terminal during the application of pressure by the clamping apparatus.

In a further aspect there is provided a clamping apparatus for use in a laser welding system, the clamping apparatus comprising:
a support part having a clamping face;
a plurality of clamping elements extending from the clamping face; and
a plurality of spring elements, wherein:
each of the plurality of clamping elements is mounted on a respective spring element of the plurality of spring elements;
each of the plurality of clamping elements is arranged to provide a compressive force to a respective connection tab of a busbar assembly when a compressive force is applied to the support part, to press each respective connection tab onto a corresponding terminal of an electrical cell of a cell array; and
each spring element is configured to compress when the compressive force is applied to the support part and when the corresponding clamping element mounted on the spring element contacts the respective connection tab to be laser welded.

Because each of the clamping elements is able to individually compress when the clamping apparatus is brought into proximity and pressed against a cell array, such that the clamping elements each press against a respective connection tab to be laser welded to a terminal of the cell array, any variation in position of the terminals can be accounted for and a secure weld of each terminal to its connection tab can still be achieved. That is, the terminals of the cells of the cell array are arranged approximately in an x-y plane, but, there may be some Z-position variation. For example, Z-position variation may arise due to small mis-alignment of the cells in the array, and/or variation in the dimensions of the cells in the array. Because the clamping elements are each mounted on a spring element, which can compress to vary the Z-position of the clamping end of the clamping element (e.g. in contact with the connection tab to be welded), each clamping element can clamp its respective connection tab to the corresponding terminal with good/close contact, without other connection tabs being clamped too forcefully to their respective tabs and/or without other connection tabs being in too little, or no, contact with their respective tabs, both of which conditions may result in a substandard weld connection. In short, each individual cell terminal/connection tab pair has an individual clamping force requirement for good quality welding, because the terminals may be in different ‘Z’ locations, and the individually sprung clamping elements provide this individual clamping force by facilitating each clamping element to be able to adjust position independently, whilst maintaining a low profile (i.e. remining close to the support part) as discussed in detail below.

Each of the plurality of clamping elements may be arranged to provide a compressive force to a respective connection tab of a busbar assembly, to press the respective connection tab onto a corresponding terminal of an electrical cell of a cell array, during one or more of:
aligning the busbar assembly with the cell array;
pre-clamping the busbar assembly with the cell array;
during measuring processes to ascertain the distance from laser head to welding location; and
during the laser welding.

Each clamping element may comprise a mounting end located proximal to the spring element and a contact end configured to engage a connection tab to be laser welded. Each clamping element and corresponding spring element may comprise a central space from the mounting end to the contact end to allow the passage of laser light therethrough to perform the laser welding.

The spring element may comprise at least one spring finger portion extending inwardly towards the central space of the clamping element. The clamping element may be mounted on at least one spring finger portion of the spring element. The spring element may comprise a circular single-turn or multi-turn wave spring, which may have a diameter matching the diameter of the clamping element rear face.

The spring element may comprise a plurality of spring finger portions and the clamping element may be mounted on the plurality of spring finger portions of the spring element. Preferably the clamping element is mounted on three spring finger portions of the spring element.

Each clamping element may comprise a peripheral outer wall extending between the mounting end and the contact end; and each spring element may comprise: a peripheral spring portion located around at least an outer portion of the peripheral outer wall at the mounting end of the corresponding clamping element; and a corresponding spring finger portion or spring contact portion extending from the spring curved portion inwardly towards the central space of the clamping element, wherein the clamping element is mounted on the spring finger portion of the spring element. Preferably, the spring element comprises three peripheral spring portions and three corresponding spring finger portions.

Each clamping element may be configured to rotate about a rotation axis oriented centrally through the central space.

Each spring element may be configured to compress in a partial portion of the spring element when the compressive force is applied to the support part and when the corresponding clamping element mounted on the spring element contacts the respective connection tab to be laser welded, thereby allowing the corresponding clamping element to tilt with respect to the clamping surface during clamping.

The support part may comprise a clamping plate comprising the clamping face, and a back plate parallel with the clamping plate; and each spring element may comprise a spring plate sandwiched between the clamping plate and the back plate to hold each spring element in the support part, wherein each spring element extends from the spring plate.

The clamping apparatus may comprise one or more of: a plurality of individual spring plates each corresponding to a respective clamping element of the plurality of clamping elements; and a common spring plate comprising a plurality of spring plates corresponding to the plurality of clamping elements.

The spring finger portion may comprise an elongated connection tab portion. The spring finger portion may be bent so that the elongated connection tab portion is in a different plane to the clamping face, toward the clamping face. The clamping element may be mounted on the elongated connection tab portion.

The spring finger portion may comprise the elongated connection tab portion and an end connection tab portion. The spring finger portion may be bent so that the elongated connection tab portion and the clamping face are in substantially parallel planes. The clamping element may be mounted on the end connection tab portion.

Each spring element may be configured to provide, when compressed, a linear force towards e.g. a respective connection tab to be welded, of up to 12 N, for example, 4 N.

Each spring element may be configured to allow the position of the corresponding clamping element with respect to the clamping face, when compressed, to move along a direction substantially perpendicular to the clamping face by up to 2.5 mm, for example, 2.2 mm.

The spring elements may be made of steel, for example, C1095 blue spring steel or other similar stainless steel alloys. The spring elements may comprise flat spring portions formed in a spring sheet of between 0.2 and 0.8 mm sheet thickness (i.e. Z dimension). For example, the spring sheet may be around 0.5 mm sheet thickness.

In a further aspect there is provided a method of laser welding a busbar assembly to a plurality of electrical cells, the method comprising:
locating the busbar assembly comprising a plurality of connection tabs on a welding face of the cell array, wherein each of the plurality of connection tabs is located on a corresponding terminal of a corresponding electrical cell;
using any clamping apparatus disclosed herein to provide, via the plurality of clamping elements and corresponding spring elements, a compressive force to each connection tab and press the connection tab onto the corresponding terminal; and
laser welding each connection tab to the corresponding terminal during the application of pressure by the clamping apparatus.

In a further aspect there is provided a control system comprising one or more controllers, the control system configured to control a laser welding system to perform a welding process to laser weld a busbar assembly to a cell array comprising a plurality of electrical cells, by:
locating the busbar assembly comprising a plurality of connection tabs on a welding face of the cell array, wherein each of the plurality of connection tabs is located on a corresponding terminal of a corresponding electrical cell;
using any clamping apparatus disclosed herein to provide, via the plurality of clamping elements and corresponding spring elements, a compressive force to each connection tab and press the connection tab onto the corresponding terminal; and
laser welding each connection tab to the corresponding terminal during the application of pressure by the clamping apparatus.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments will now be described by way of example only, with reference to the accompanying figures, in which:

FIG. 1 shows a group of cylindrical cells mechanically bonded together;

FIGS. 2A and 2B show a portion of an assembly comprising a busbar assembly having connection tabs connected to terminals of respective cells in a group of cylindrical cells;

FIG. 3 shows a clamping apparatus according to examples of the present disclosure;

FIG. 4 shows a cross section through a clamping element according to examples of the present disclosure;

FIG. 5 shows a back view of a clamping plate according to examples of the present disclosure;

FIG. 6 shows a portion of a spring plate according to examples of the present disclosure;

FIGS. 7A to 7C shows schematic spring finger portions according to examples of the present disclosure;

FIG. 8 shows a method of laser welding a busbar assembly to a plurality of electrical cells according to examples of the present disclosure;

FIG. 9 shows a method of laser welding a busbar assembly to a plurality of electrical cells according to examples of the present disclosure; and

FIG. 10 shows a control system according to examples of the present disclosure.

### DETAILED DESCRIPTION

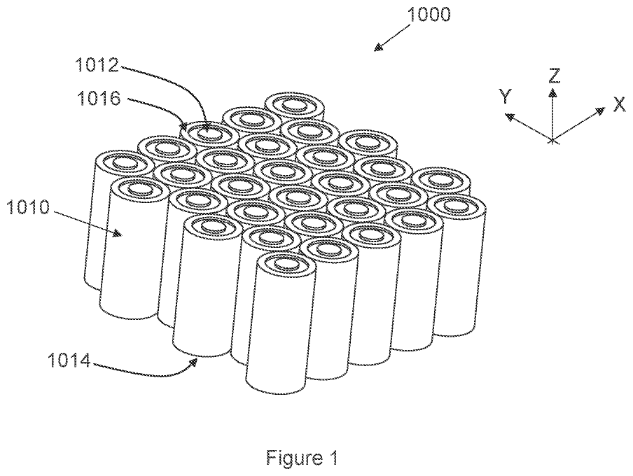

FIG. 1 shows a block 1000 comprising a plurality of cylindrical cells 1010. The cells may be mechanically joined together, for example via an adhesive on the cylindrical surfaces of the cells 1010. The cylindrical cells 1010 may be arranged in a side-to-side configuration. The block 1000 may comprise rows of cells 1010, with each row being offset from the adjacent rows by a distance approximately equal to the radius of one of the cylindrical cells, thereby improving the efficiency with which the cells can be packaged into a given volume. It will be understood that other configurations of the block 1000 are also useful, and in some examples, the cells need not be cylindrical.

The cylindrical cells 1010 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used.

Each cell 1010 comprises a positive terminal and a negative terminal. The positive terminal may be provided by a steel end cap in a central region of the first end 1012 of the cell. The negative terminal in some examples may be provided by a steel cylindrical cap or plate at the second end 1014. The negative terminal in some examples may be provided by a steel cylindrical case which covers the second end 1014, the entire cylindrical surface between the first 1012 and second ends 1014, and a peripheral region 1016 of the first end surface. The peripheral region 1016 of the first end surface may also be referred to as a “shoulder” region of the first end surface 1012. In commercially-available cells, it is sometimes the case that the end cap that defines the positive terminal on the first end surface 1012 protrudes beyond the shoulder region 1016 of the first end surface 1012, although this is not the case in the cells shown in FIG. 1.

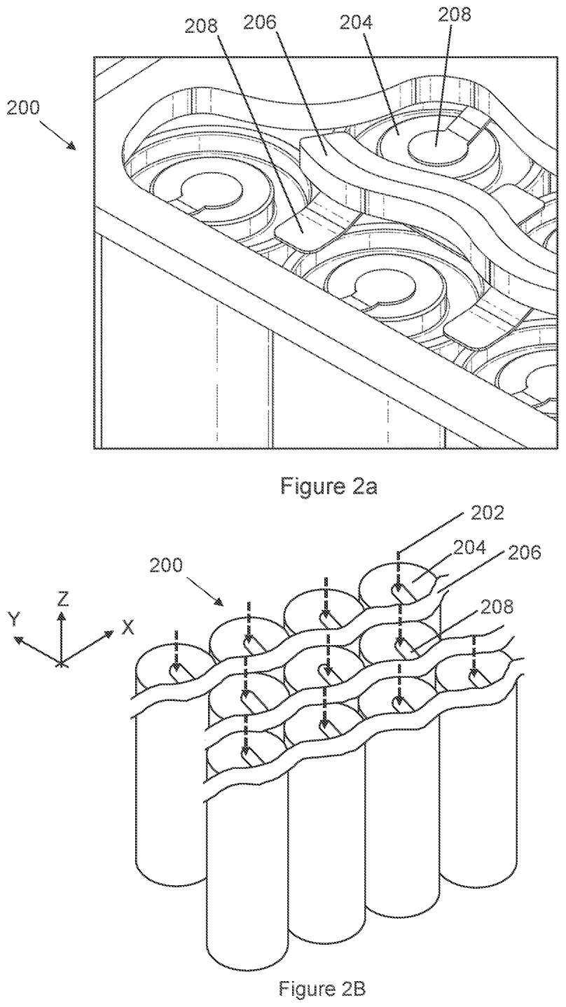

FIGS. 2A and 2B show a portion of an assembly 200 comprising a busbar assembly 206 having connection tabs 208 connected to terminals 204 of respective cells in a group of cylindrical cells. The assembly 200 comprises a group of cells 1000 shown in FIG. 1. A busbar assembly 206 is provided adjacent to the first ends of the cells. The busbar assembly 206 is arranged to electrically connect all of the cells within the group in parallel with one another.

The busbar assembly 206 is configured to electrically connect to the terminals of a type (e.g. the positive terminals, or the negative terminals) of all of the cells. The busbar assembly 206 may, for example in an example connecting to the negative terminals of the cells, comprise a negative collection plate (e.g. comprising aluminium) and connect to the negative terminals of the cells by a thin metallic sheet (e.g. comprising copper, for example copper plated with nickel). The busbar assembly 206 may, for example in an example connecting to the positive terminals of the cells, comprise a positive collection plate (e.g. comprising aluminium) and connect to the positive terminals of the cells by a thin metallic sheet (e.g. comprising copper, for example copper plated with nickel).

In examples in which the positive terminals of the cells are located at one face of the assembly 200 and the negative terminals of the cells are located at an opposite face of the assembly 200, there may be two busbar assemblies 206—one to connect to the positive terminals and another to connect to the negative terminals. In examples in which the positive and the negative terminals of the cells are located at the same face of the assembly 200 (for example, the positive terminals are located in the centre of each of the cell ends, and the negative terminals are located at a shoulder region of the same cell ends), there may one busbar assembly 206 comprising both a positive collection plate and a negative collection plate each having respective thin metal sheets by which to connect to the corresponding terminals. In such a single busbar assembly 206 example, an insulating layer may be positioned between the negative collection plate and corresponding thin metallic sheet, and the negative collection plate and corresponding thin metallic sheet, to ensure that the positive and negative collection plates are electrically isolated from one another.

The busbar assembly 206 comprises a plurality of connection tabs 208 (e.g. formed from the thin metallic sheet) extending away from the body of the corresponding collection plate (that is, a plurality of positive terminal connection tabs (formed from the thin metallic sheet bonded to the positive collection plate) extend away from the body of the positive collection plate, and/or a plurality of negative terminal connection tabs (formed from the thin metallic sheet bonded to the negative collection plate) extend away from the body of the negative collection plate). The connection tabs 208 can be welded to the corresponding terminals of the cells in the group of cells 1000, and the positioning of the connection tabs is such that each cell 1010 can be connected to a respective connection tab 208 when the busbar assembly 206 is correctly positioned relative to the group of cells 1000.

The busbar assembly 206 may be positioned adjacent to the group of cells 1000 such that the positive and/or negative connection tabs 208 are in contact with the corresponding positive and/or negative terminals of the cells within the group of cells 1000. The connection tabs 208 are then electrically and mechanically connected to the respective terminals by laser welding. It will be understood that other methods of electrically and mechanically connecting the connection tabs to the terminals, including but not limited to other welding techniques, are also useful.

Each of the connection tabs 208 is positioned adjacent to a respective terminal of a single cell within the group of cells 1000, and a portion of the connection tab may be laser welded to the respective terminal. When laser welding the connection tabs 208 to the respective terminals, it is important to control the amount of energy (e.g. laser power, laser focus) used in the weld to ensure that the internal components of the cells are not damaged by the heat generated during the welding process (that is, damage caused by excessive and/or prolonged energy density on and/or in the material). Accordingly, laser welding may be a particularly suitable technique, as it enables precise control of the amount of energy applied during each weld operation.

Ensuring that the connection tabs 208 are in good electrical and mechanical contact with the respective terminals during welding the connection tabs to the respective terminals (and thus once welding has been performed) is important for the operation of the assembly 200. When welding the connection tabs to the respective terminals, particularly in a desirable higher speed welding process, ensuring good contact between the connection tab and the terminal, with as little gap between them as possible, is desirable. A typically acceptable gap between the two surfaces prior to welding may be, at most, 10% of the required penetration depth of the laser weld. In the case of welding a connection tab to a terminal (which may be termed “lattice to cell” welding), this 10% maximum gap may be equivalent to a maximum gap condition of 30 μm. Examples disclosed herein provide a clamping plate which can provide this level of contact (<30 μm gap) and which may be used during laser welding to contact each connection tab to its respective terminal.

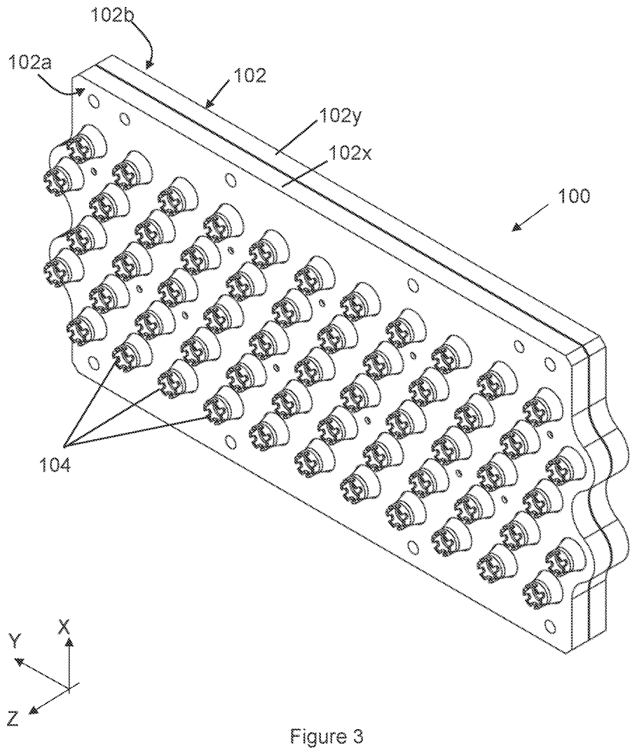

FIG. 3 shows an example of a clamping plate 100. Such a clamping plate may be used in a laser welding system with an arrangement such as that of FIGS. 2A and 2B, to provide compressive force 202 to a plurality of connection tabs 208 of a busbar assembly 206 and press each connection tab 208 of the plurality of connection tabs onto a corresponding terminal 204 of an electrical cell 1010 of a cell array 1000.

The clamping apparatus 100 comprises a support part 102 having a clamping face 102a. The support part 102 is a rigid plate which may be moved and pressed against a busbar assembly to press the connection tabs of the busbar assembly onto terminals of a cell array, for laser welding the connection tabs to respective terminals. For example, the clamping apparatus 100 may be controlled in a welding system to slide towards (for example, by a sliding rail system) and clamp down on a supercell (that is, press the connection tabs of the busbar assembly onto the terminals of the cells in the supercell to which is it to be welded). The support part 102 may comprise, for example, a machined aluminium plate (or in some examples, a pair of plates 102x, 102y sandwiched together.

The clamping apparatus 100 comprises a plurality of clamping elements 104 which are supported on the support part 102 and extend from the clamping face 102a. Each of the plurality of clamping elements 104 is arranged to provide a compressive force. Each of the plurality of clamping elements 104 may be arranged to provide a compressive force 202 to a respective connection tab 208 of a busbar assembly 206, to press the respective connection tab 208 onto a corresponding terminal 204 of an electrical cell 1010 of a cell array 1000, during one or more of, for example: aligning the busbar assembly 206 with the cell array 1000; pre-clamping the busbar assembly 206 with the cell array 100; during measuring processes to ascertain the distance from laser head to welding location; and during the laser welding of the connection tabs 208 to the corresponding terminals 204 of the cells 1010 in the array 1000.

The clamping apparatus 100 may comprise between 20 and 100 clamping elements 104 104. For example, the clamping apparatus 100 may comprise between 40 and 80 clamping elements. The example of FIG. 3 shows a clamping apparatus 100 comprising 60 clamping elements, which may be used in laser welding connection tabs of a busbar assembly to a cell array comprising 60 electrical cells (or a supercell array comprising a (e.g. whole number) multiple of 60 cells, e.g. 120 or 180 cells, or e.g. 2, 5, 10 or 20 cell arrays of 60 electrical cells each). Thus each clamping element 104 is used to clamp one connection tab to its respective terminal at a time.

Each clamping element 104 may be formed of an electrically insulating material. Being electrically insulating is preferable in order to mitigate against shorting the battery cell, busbar connections, or entire supercell. It is also preferable that they are non-compressible, so as to not distort or alter their dimensions. The insulating material may be, for example, made of ceramic or plastic material (e.g. PTFE plastic). The clamping elements may also have low reflectivity which aids the precision laser welding process by mitigating against undesirable stray laser reflections from the clamping element surface.

Each clamping element 104 may be formed of a rigid material, i.e. be substantially incompressible under normal clamping use). Being rigid is preferable to allow for a sufficient compressive force to be applied to a tab to hold it onto the terminal to which is it to be laser welded and reduce the possibility of a gap forming between the two which may cause a substandard weld join to be formed. That is, a strong, hard clamping surface to contact and press onto a tab to be welded is desirable.

Each clamping element may be a three-dimensional printed clamping element (e.g. a 3D printed plastic clamping element) in some examples. Three-dimensional printing of the clamping elements may be useful as a cost effective way of forming the clamping element with accurate dimensions which also allows for flexibility in altering the design (e.g. the particular shape) of the clamping element, if desired.

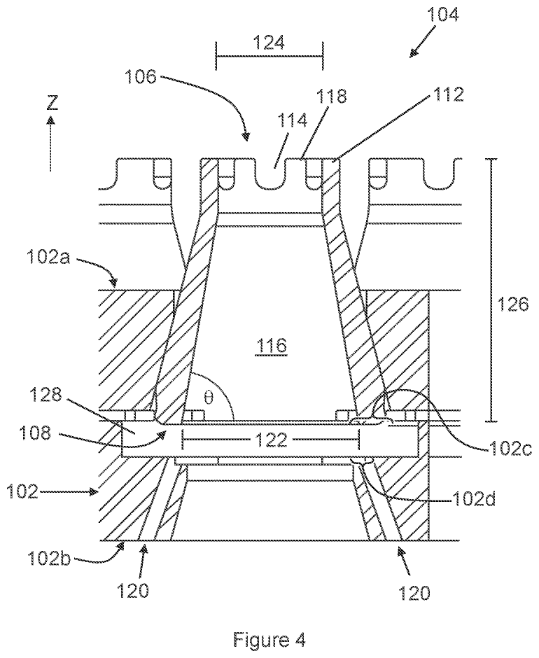

FIG. 4 shows a cross section through a clamping element 104. The clamping element 104 comprises a peripheral outer wall 112 and a central space 116 configured to allow the passage of laser light therethrough to perform the laser welding. The clamping element has a mounting end 108, which is configured to mount on the support part 102; and a contact end 106, which is configured to engage a connection tab to be laser welded. The mounting end 108 is larger than the contact end 106. The clamping element 104 has a truncated conical shape in FIG. 4. Another example clamping element may have a truncated pyramidal shape. A (truncated) conical shaped clamping element may have a right circular (truncated) cone shape, i.e. is symmetric about a central axis normal to the (truncated) cone base.

Laser welding may be used to weld together the connection tabs with the respective terminals of the cell array. An example laser welding system may use a high-powered laser to produce a laser beam which is directed towards the spot to be welded. Clamping plates discussed herein, which comprise clamping elements 104 with an outer wall 112 and a space 116 through the middle, may be used to clamp connection tabs with respective terminals during welding (and possibly at other stages in manufacturing) by producing a clamping force onto a connection tab via the outer wall 112 of the clamping element, and allowing the laser beam to have access, through the central space 116, to the connection tab to be welded. In some examples, a further beam, such as a monitoring beam for checking the weld process or a measurement beam for connection tab Z-position measurement, may also pass through the central space 116 of the clamping element 104, for example during welding. Laser welding systems are able to produce welds very rapidly and with fine control over the weld power and shape. They are therefore particularly useful in situations in which several components in close proximity must be rapidly welded together.

Using a tapered shape of clamping element 104, such as a truncated cone, allows a laser to access a plurality of welding spots covered by different respective clamping elements at the same time (for example, up to 15 spots (located at respective connection tabs) may be accessed by the laser at the same time). A tapered (e.g. conical) shape of clamping element 104 allows for a laser beam to enter the space 116 within the clamping element 104 at the mounting end 108 and if the laser enters the space 116 at an angle away from the central axis of the clamping element 104 (i.e. along a line perpendicular to the mounting end 108 and contact end 106) then the laser shadow (that is, a region which is inaccessible/blocked to the laser) is reduced compared to e.g. a cylindrical/uniform area cross section clamping element. Having a short/shallow height dimension 126 between the mounting end 108 and the contact end 106 is also desirable to reduce the laser shadow compared with a longer height dimension 126.

The clamping elements may have an internal dimension 122 across the mounting end through a central point of the mounting end face of between 10 mm and 15 mm (e.g. between 12 mm and 13 mm, for example, 12.5 mm). The clamping elements may have an internal dimension 124 across the contact end through a central point of contact end face of between 5 mm and 9 mm (e.g. between 6 mm and 8 mm, for example, 7.5 mm). The distance between the mounting end 108 and the contact end 106 of a clamping element may be between 14 mm and 21 mm (e.g. between 17 mm and 18 mm).

Each clamping element 104 may be rotatably mounted (e.g. in the support part 102 or at the clamping face 102a of the support part 102) to allow for rotation of the clamping element 104 about a rotation axis substantially normal to the clamping face 102a. If the contact tab and/or terminal to be welded together are oriented at an angle away from parallel to the contact end 106 face of the clamping element 104 to be welded, then a rotatably mounted clamping element 104 (in particular, a spring mounted rotatable clamping element 104, discussed in more detail below) may advantageously be able to move around/rotate and accommodate the angular displacement of the tab/terminal away from parallel and provide a good pressure application to in turn achieve a good quality weld.

During laser welding, it is undesirable to have oxygen in the vicinity of the weld region because this can cause oxidation at the weld site which can weaken the weld. Therefore, the weld site may be flooded with a different gas (which may be called a displacement gas or shielding gas) to displace air, thereby removing oxygen from the weld site. It may also be desirable to remove other gases from the weld site, such as nitrogen or other gases naturally occurring in ambient air. An inert gas may be used as a displacement gas to flood the weld site prior to welding. For example, argon may be used to flood the weld site prior to welding and be present at the weld site during welding, so welding can take place without oxygen (or any other reactive gas) present. Examples disclosed herein allow for a displacement gas to be used to push air (i.e. oxygen) away from the weld site for welding.

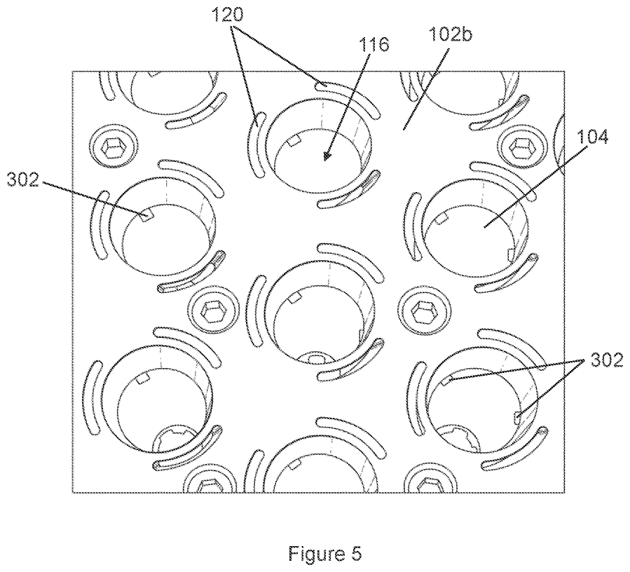

Each clamping element 104 may comprise an opening 114 through the peripheral outer wall 112. The opening 114 is configured to allow a flow of gas between the central space 116 and outside the clamping element 104. For example, a displacement gas (e.g. argon) may be introduced to the central space 116 within which the weld is to take place, and the introduction of the displacement gas causes air (oxygen) within the central space 116 to be pushed outside the clamping element 104 away from the weld site. The displacement gas may be introduced to the space 116 via one or more gas channels 120, which are described in more detail below in relation to FIG. 5. A gas (e.g. oxygen) sensor may be present in the vicinity of the weld location(s) to determine gas levels e.g. oxygen levels. FIG. 5 illustrates an example of a clamping apparatus indicating how a displacement gas may be provided to the spaces 116 within the clamping elements 104.

FIG. 4 also shows a mounting portion 102c and a mounting portion rim 102d of the support part 102b which are defined in order to define an example location of the gas channels 120. The clamping element 104 may be mounted on the mounting portion 102c, and the gas channels 120 may be located through the mounting portion rim 102d. Also shown in FIG. 4 is a displacement space 128 at the mounting end 108 of the clamping element 104, which allows for the clamping element 104, in examples where it is mounted on a spring element in the support part 102, to move back in to the displacement space 128, for example, to accommodate any variation in Z positioning of tabs to be clamped.

The opening 114 in the example of FIG. 4 is shown as a series of openings at the contact end 106 of the clamping element 104, but in other examples the opening 114 may be, for example, one or more holes passing through the peripheral outer wall 112 between but not necessarily coinciding with the contact end 106 and the mounting end 108. In some examples, displacement gas may be provided into the space 116 of the clamping elements 104 at a gas inlet located at the mounting end 108 of the clamping element 104, and the opening(s) 114 may be located at the contact end 106 of the clamping element 104, so that a displacement gas may flow from the mounting end 108 to the clamping end 106 and push out air (oxygen) from the mounting end 108 along the clamping element 104 and out of the openings 114, thereby flushing the whole space 116 within the clamping element 104 and filling it with the displacement gas (e.g. argon). It may be desirable to obtain a laminar gas flow out from the central space 116 to outside the clamping element 104, and the type of gas flow (e.g. laminar, turbulent) may be controlled by controlling the flow rate of displacement gas to the gas channels 120. However, an important aim is to remove the presence of reactive gases (e.g. oxygen) from the weld location regardless of the displacement gas flow type used to achieve this.

The clamping element 104 in FIG. 4 has a contact end 106 which is configured to be located on a connection tab to be laser welded. The contact end 106 in this example includes the openings 114 as part of a castellated contact end 106. The contact end 106 is castellated to provide a plurality of contact protrusions 118 configured to contact the connection tab to be laser welded and allow for the application of pressure to the connection tab, and a plurality of openings 114 (spaces between the contact protrusions 118) configured to allow a flow of gas (e.g. air) between the central space and outside the clamping element (e.g. out from the central space 116 to outside the clamping element 104).

The example of FIG. 4 has a contact end 106 comprising six contact protrusions and six openings alternately arranged around the contact end 106. Having six contact protrusions and six openings provides enough contact material to clamp the tab to the terminal firmly enough to achieve a good quality weld, provide enough space for air (oxygen) to be pushed out from the central space 116, and, in the event that a contact protrusion breaks, enough contact protrusions remain to still provide sufficient clamping. Of course, other numbers, such as five, seven, or eight contact protrusions and five seven, or eight openings may also be used in other examples. In some examples, the contact protrusions may be larger, or smaller, or vary in size (e.g. alternate large-small-large-small), compared with the size of the openings (wherein the size may be taken to be a distance around the peripheral wall 112 at the contact end 106, e.g. 10% of the circumference at the contact end 106). The depth (e.g. the distance from the contact end 106 into the peripheral wall) of the contact end openings 114 may also vary—it is desirable to have the depth large enough to allow for sufficient airflow out from the space 116, and small enough that the remaining contact protrusions 118 are not so long that they may break more easily than a shorter protrusion 118.

Thus, in these examples, the castellation 114, 118 cut into the tip (contact end 106) of each cone-shaped clamping element 104 may aid with the flow and delivery of the displacement gas (e.g. argon). The support part 102 and ceramic nozzles 104 also act as the delivery system of the displacement gas. As noted above, removal of the oxygen content from the weld location is important for maintaining low porosity and desirable microstructure features. This may be accomplished by examples disclosed herein through flooding the area 116 with argon gas, displacing the oxygen and nitrogen heavy air. Typical prior art shielding gas systems within welding processes use a box to encase the surrounding volume which is filled with argon. A drawback to this is the slow response time of the system, as the volume of gases to be exchanged is large, and the consumption of expensive argon gas is high. By utilising each clamping element 104 as its own “box”, with the argon feed running through the support part 102, the purge time to reduce the oxygen content at the weld locations is drastically reduced, as well as minimising the consumption of argon (to, for example, 1 ltr/min of a clamping element vs 200 ltr/min for a traditional box). This process is again aided by the castellations cut into the tip of each clamping element 104, which act as channels for the oxygen and air to escape quickly from as the argon is pumped in. A result of this arrangement is consistent levels of shielding gas on each and every weld location within the clamping elements 104.

FIG. 5 shows a back view (a back face 102b) of a support part 102. The support part 102 in this example comprises a plurality of gas channels 120. Each clamping element 104 in this example is configured to receive a gas (e.g. argon) supplied into the central space 116 via at least one corresponding gas channel 120 of the plurality of gas channels 120 of the support part 102 (in this example, there are three gas channels 120 per clamping element 104). Each clamping element 104 may be configured, as shown in FIG. 5, to receive gas supplied into the central space 106 via a plurality of dedicated arc shaped gas channels 120 of the support part 102 arranged around the mounting end of the clamping element 104. The peripheral outer wall 116 of each clamping element 104 may be mounted at a respective mounting portion (portion 102c in FIG. 4) of the clamping face of the support part 102. Each mounting portion 102c may extend inwardly beyond the peripheral outer portion 116 of the clamping element 104 to form a mounting portion rim (portion 102d in FIG. 4), and the at least one corresponding gas channel 120 may be located through the mounting portion rim 102d.

The support part 102 may comprise, or be connected to, a supply channel (not shown) connected to the plurality of gas channels 120. The supply channel 120 is configured to allow the supply of gas (e.g. argon) to each of the central spaces 116 of the clamping elements 104 via the gas channels 120. For example, the gas may be supplied from a single gas source to a plurality of clamping elements 104. In an example, a clamping apparatus may comprise 60 clamping elements, and each group of 15 clamping elements may be supplied with displacement gas from a single gas supply source (or a single gas feed pipe, with each of the four feed pipes supplied by a single gas supply sources).

In this way, the gas channel opening in the support part 120 is close to the clamping element 104, and has a large enough size to allow gas to easily flow/be provided into the space 116 of the clamping element 104 through the support part 102b (due to the arc shape which follows the shape of the outer peripheral wall of the clamping element 104 within the peripheral outer wall at the mounting end 108), while sufficient support part material remains between the gas channels 120 and between the gas channels 120 and the central opening into the space 116 to be structurally strong and allow pressure to be provided during clamping by the mounted clamping elements 104 with low risk of the support part 102 deforming or breaking. Also just visible in FIG. 5 are spring elements 302 which are discussed in greater detail below.

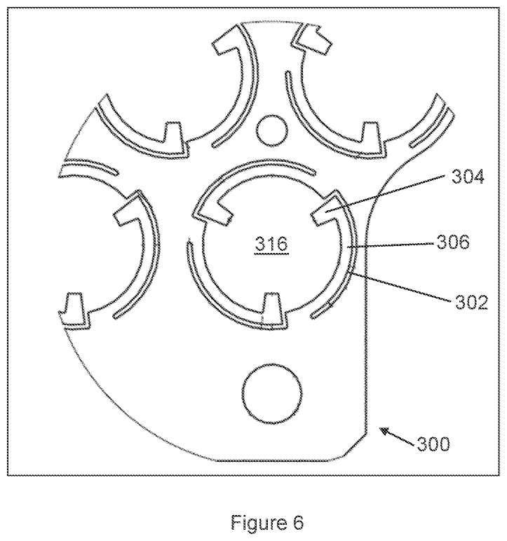

As mentioned above, the clamping elements 104 may be sprung so that they are individually movable in the Z-direction (that is, towards/away from the tab to be welded when the clamping apparatus 100 is in use and proximal to or in contact with tabs to be welded). FIG. 6 shows a portion of a spring plate 300. Each circular arrangement may be considered to be a spring element 302, and corresponds to a conical clamping element and may be located at the mounting end 108 of a clamping element 104 (i.e. each clamping element 104 may be considered to be mounted on a spring element 302). The spring elements 302 (in some examples, the spring plate 300) may be made of a resilient elastically deformable material, for example, steel. A particular example is C1095 blue spring steel of 0.5 mm sheet thickness (Z dimension).

As noted above, the terminals 204 (and tabs 208) to be welded may not be in the same plane; that is, they may be vertically displaced (displaced in the Z-direction) with respect to each other. It is important to obtain an even and consistent clamping force across the plurality of tabs to be welded (e.g. an array of 60 tabs), despite the possible range of battery terminal heights which may be present. For example, a range of battery cell heights (i.e. a difference in electrical terminal locations out of plane of the terminals) may be up to 1.1 mm between neighbouring locations (i.e. neighbouring electrical cells). Using, for example, a spring plate 300, as illustrated in FIG. 5, may allow for this height difference to be accommodated and allow for a weld process to take place in which the risk of a poor quality weld arising from the presence of a gap between the tab and terminal to be welded together is mitigated against.

Each clamping element 104 may be mounted at the clamping face 102a of the support part 102 via a corresponding spring element 302. The spring elements 302 may be configured to compress as the clamping apparatus 100 is positioned to cause the clamping elements 104 to provide a compressive force (and, for example, press the respective connection tabs of a busbar assembly into corresponding terminals for laser welding the connection tabs to the terminals). That is, examples disclosed herein provide a clamping apparatus 100 for use in a laser welding system, the clamping apparatus 100 comprising: a support part 102 having a clamping face 102a; a plurality of clamping elements 104 extending from the clamping face 102a; and a plurality of spring elements 302. Each of the plurality of clamping elements 104 is mounted on a respective spring element 302 of the plurality of spring elements. As described above, each of the plurality of clamping elements 104 is arranged to provide a compressive force to a respective connection tab 208 of a busbar assembly 206 when a compressive force is applied to the support part 102, to press each respective connection tab 208 onto a corresponding terminal 204 of an electrical cell 1010 of a cell array 1000. Each spring element 302 is configured to compress when the compressive force is applied to the support part 102 and when the corresponding clamping element 104 mounted on the spring element 102 contacts the respective connection tab 208 to be laser welded.

Therefore, spring mounting the clamping elements 104 allows for each individual cell terminal/connection tab pair to be welded to be pressed together for welding with the individual force suitable for that particular pair, which may vary across the terminal array due to a variation in ‘Z’ locations, allowing for multiple welds to be made simultaneously, and/or during the same arrangement and positioning of components to be connected, by catering for the positioning of the components to be welded together at each individual weld location.

In a particular example, there may be a clamping apparatus 100 comprising ceramic cone-shaped nozzles as clamping elements 104, arranged in a group of 60. The clamping elements may be positioned according to the battery cell pitch (i.e. the height/Z-displacement of the terminal of each electrical cell in the cell array). In some examples as described below, each clamping element 04 may be individually spring-loaded. Each clamping element 104 is configured to apply a clamping force onto each connection tab 208 of the busbar apparatus 206. The clamping element 104 can press the tab 208 onto the surface 204 of the cell 1010 and enables successful welding of the two materials, without “lack of fusion” type failures which can arise when there is an excessive gap between the tab 208 and the terminal 204 during the weld.

Each of the plurality of sprung clamping elements may be arranged to provide a compressive force to a respective connection tab of a busbar assembly, to press the respective connection tab onto a corresponding terminal of an electrical cell of a cell array, during one or more of: aligning the busbar assembly with the cell array; pre-clamping the busbar assembly with the cell array; during measuring processes to ascertain the distance from laser head to welding location; and during the laser welding.

Each clamping element 104 may be located with its mounting end 108 located proximal to the spring element 302 (and thus its contact end 106 configured to engage a connection tab to be laser welded). Each clamping element 104 and corresponding spring element 302 may comprise a central space 116, 316 to allow the passage of laser light therethrough to perform the laser welding. When the clamping element 104 is mounted on its spring element 302, the opening at the mounting end 108 to the space 116 of the clamping element 104 may align with the space 316 in (e.g. the centre of) the spring element 302 so that together, there is a space through the clamping element 104 and spring element 302 through which laser light may pass for laser welding.

The spring element 302 may comprise at least one spring finger portion 304 extending inwardly towards the central space 116 of the clamping element 104. The clamping element may be mounted on the at least one spring finger portion 304 of the spring element. As shown in FIG. 6, this example has three spring finger portions 304 evenly distanced around the central space 316. The clamping element may be mounted on the spring finger portions 304 so that the peripheral wall 112 rests against the spring finger portions 304. Three spring finger portions provides full support to the clamping element 104, in that it provides a “triangular” support, and the clamping element 104 cannot tilt unsupported with respect to the support part 102. Also, if the clamping element is pressed against a connection tab to be welded, and the plane of the connection tab (or the terminal to which the connection tab is to be pressed for welding) is not coplanar with the plane of the contact end of the clamping element, the clamping element is able to tilt in any direction away from the normal and accommodate the non-planar connection tab and still provide a clamping/compressive force to the tab by way of the three (or more in other examples) supporting spring finger portions which may be compressed by different amounts to accommodate the tilt angle. In other examples, the spring element may comprise a circular single-turn (similar to a washer having a plurality of peak and trough undulations out of the washer plane) or multi-turn wave spring (e.g. a crest-to-crest multi-turn wave spring is similar to a stack of washers each having a plurality of peak and trough undulations out of the washer plane, wherein the peak of a washer component contacts the trough of an adjacent washer component; a nested multi-turn wave spring is similar to a stack of washers each having a plurality of peak and trough undulations out of the washer plane, wherein the peaks of adjacent washer components are proximal to each other), which may have a diameter matching the diameter of the clamping element rear face. A wave spring may have a height of around half an equivalent coil spring (by equivalent, this means the wave spring may have comparable force properties to a coil spring but may be up to half the dimension along the cylindrical axis of the spring).

In the example of FIG. 6, each spring element 320 comprises a peripheral spring portion 306 located around the outer region of the central space 316 with a corresponding spring finger portion 304 extending from the peripheral spring portion 306 inwardly towards the central space 316. When the corresponding clamping element 104 is mounted on the spring finger portion 304 of the spring element 302, the peripheral spring portion 306 is located around at least an outer portion of the peripheral outer wall 112 at the mounting end 108 of the clamping element 104. The spring finger portions 304 extend from the peripheral spring portions 306 inwardly towards the central space 116 of the clamping element 104.

Three spring finger portions 304 in an arrangement having peripheral spring portions and extending spring finger portions as shown in FIG. 6, may provide an advantageous spring arrangement, because there are a minimum of (three) spring finger portions 304 extending from respective peripheral spring portions 306 to provide a stable (three-point) base for the clamping element 104 mounted thereon, and allows for each peripheral spring portion 306 to extend around a maximum (approximately a third of the circumference) of the outside of the central space, allowing for a maximum Z-range variation for a stably-mounted clamping element. Each spring element may be configured to allow the position of the corresponding clamping element with respect to the clamping face, when compressed, to move along a direction substantially perpendicular to the clamping face (the Z direction) by up to 2.2 mm in some examples.

Each spring element may be configured to provide, when compressed, a linear force towards e.g. a respective connection tab to be welded, of up to 12 N. This may be provided through the thickness of the spring elements (e.g. 0.5 mm spring plate (spring finger/element) thickness), the material (e.g. stainless steel, blue spring steel) used to make the spring plates, through a multi-layer leaf spring element, through a single or multi-turn wave spring, or other means as the skilled person would be aware.

Providing a large Z-range of compression is desirable to allow for a connection tab which is not co-planar with the contact end plane of the clamping element to be clamped securely, as facilitated by the clamping element being able to tilt on the supporting spring finger portions which can compress by different amount to provide the tilt. However, it is also desirable to maintain a low profile (a small Z-dimension) to the clamping plane (i.e. the overall height of the clamping apparatus). In a laser welding process, the welding laser fires through the centre of each clamping element to reach the lattice tab and terminal of the electrical cell. Hence, as the peripheral outer walls 112 of the clamping element 104 and the complete clamping apparatus 100 have a larger Z dimension, the range of workable angles of incidence for the laser reduces. This angle is important to keep as large as possible as it dictates how many cells can be accessed by the laser and be welded at once (i.e. for each position of the laser optical head used for welding). Limiting the movement of the laser optical head and increasing the number of welded tabs/terminals to be welded for each position of the laser optical head improves (reduces) the cycle time and improves (increases) efficiency of the manufacturing process.

Each clamping element 104 may be configured to rotate about a rotation axis oriented centrally through the central space. The clamping element 104 may, for example, be able to slide over the supporting spring finger portions 304 and rotate. This may be desirable to allow a further (rotational) degree of freedom to accommodate any non co-planar orientation of the connection tab compared with the contact end 106 plane of the clamping element 104 and allow for sufficient secure clamping. There are different ways in which the clamping element 104 may be rotatably mounted. For example, as shown in FIG. 4, a cone shaped clamping element 14 having a wider base and tapering to a smaller cross section at the contact end can, when mounted through a truncated cone shaped hole in a part of the mounting part and supported at the back by, for example, the spring element (and possibly a back plate of the support part) can rotate without being able to be removed from the support part 102.

The support part 102 may comprise a clamping plate 102x comprising the clamping face, and a back plate 102y parallel with the clamping plate 102x, as shown in FIG. 3. Each spring element 302 may comprise a spring plate 300 sandwiched between the clamping plate 102x and the back plate 102y to hold each spring element 302 in the support part 102, wherein each spring element 302 extends from the spring plate 300. In other examples, as shown in FIG. 6, the clamping apparatus 100 may comprise a common spring plate 300 comprising a plurality of spring elements 302 corresponding to the plurality of clamping elements 104. In other examples, there may be a combination of one or more individual spring plates each providing at least one spring element 302 corresponding to a respective clamping element 104, and a common spring plate 300 comprising a plurality of spring elements 302.

Hence, as the clamping apparatus 100 advances to the supercell (connection tabs and terminals of electrical cells) to provide clamping, each clamping element 104 is able to adjust independently its position relative to the battery cell that it is clamping. This helps to overcome any clamping issues arising from battery cells positioned higher in the carrier (i.e. displayed in the Z direction) from holding the array of clamping elements away from the lower/further electrical cells.

Further, in examples comprising a plurality of spring fingers 304 supporting each clamping element 104, each of the plurality of spring fingers 304 may be configured to compress individually; that is, each spring element 302 may compress in a partial portion of the spring element 302. For example, when a compressive force is applied to the support part 102 and when the corresponding clamping element 104 mounted on the spring element 302 contacts the respective connection tab to be laser welded, one or more of the spring fingers 304 supporting that clamping element 104 may compress. This allows the corresponding clamping element 104 to tilt with respect to the clamping surface 102a during clamping, for example if the connection tab and/or terminal is not co-planar with the plane of the contact end 106 of the clamping element 104. In turn, improved clamping may therefore be achieved compared with a clamping element 104 which cannot tilt to accommodate the positioning/plane of the element to be clamped.

Sprung clamping apparatuses 100 according to the above description may be made which can accommodate up to 1.5 mm of “Z” float of cell/lattice (i.e. difference in height of the terminals to be welded to respective connection tabs) in the line of the laser firing, and can accommodate different values of Z float even on neighbouring cells. Also provided by the above arrangements (e.g. through use of a leaf or finger spring, or a single or multi-layer wave spring, which is flatter than (i.e. the dimension along the central axis of the spring in the direction of head-on compression), for example, a coil spring) is a small/thin clamping apparatus thickness and therefore a high “field of view” of laser to allow for a higher number of cells to be accessed per laser position. This in contrast with using coil springs, which may increase thickness compared with a spring finger arrangement as described of up to 10 mm to each clamp side.

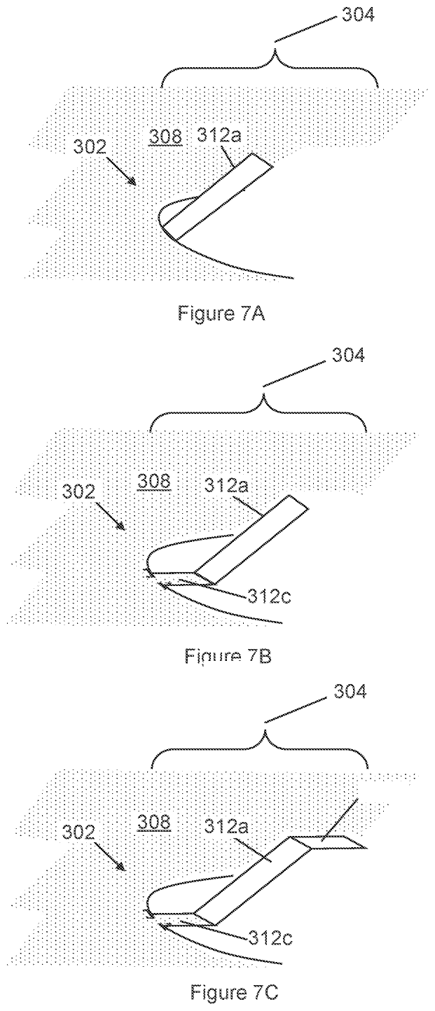

FIGS. 7a to 7c show schematic examples of spring finger portions 304 having different bent forms. FIGS. 7a to 7c each show a spring finger portion 304 comprising an elongated connection tab portion 312a. That is, the spring finger portion 304 may be bent so that the elongated connection tab portion 312a is in a different plane to the clamping face, toward the clamping face. The clamping element may be mounted on the elongated connection tab portion 312a. FIG. 7a shows an elongated connection tab portion 312a which is the spring finger portion 304 so the whole spring finger portion 304 lies out of plane with the clamping face. FIG. 7b shows an elongated connection tab portion 312a which is a partial portion of the spring finger portion 304 so part 312a of the spring finger portion 304 distal to the spring plate 300 lies out of plane with the clamping face and is connected to the spring plate 300 by a spring finger connection portion 312c which may be planar with the spring plate 300 (and the clamping face). In some examples, such as shown in FIG. 7c, the spring finger portion 304 may comprise the elongated connection tab portion 312a and an end connection tab portion 312b (FIG. 7c also shows a spring finger connection portion 312c although there may not necessarily be a spring finger connection portion 312c as in FIG. 7a). The spring finger portion 304 may be bent so that the elongated connection tab portion 312a and the clamping face are in substantially parallel planes. The clamping element may be mounted on the end connection tab portion 312b, which may be planar with the clamping face (and the spring plate 300).

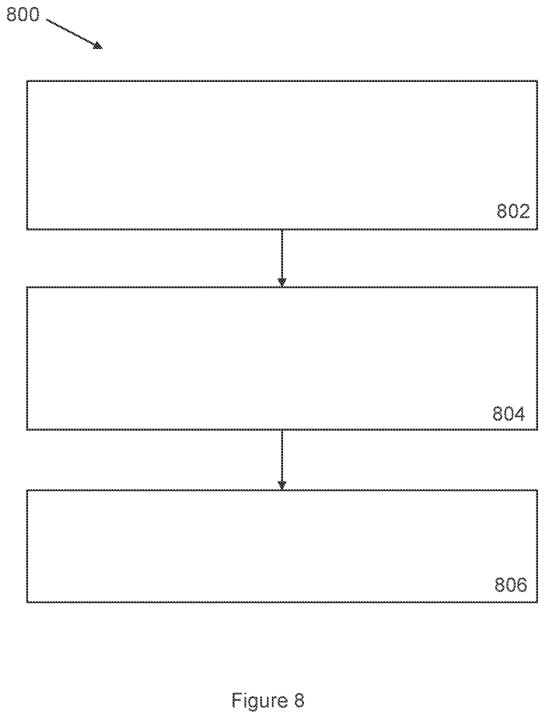

FIG. 8 illustrates a method 800 of laser welding a busbar assembly 206 to a plurality of electrical cells 1000. The method 800 comprises locating the busbar assembly comprising a plurality of connection tabs on a welding face of the cell array, wherein each of the plurality of connection tabs is located on a corresponding terminal of a corresponding electrical cell 802; using any clamping apparatus disclosed herein to provide, via the plurality of clamping elements, a compressive force to each connection tab and press the connection tab onto the corresponding terminal 804; and laser welding each connection tab to the corresponding terminal during the application of pressure by the clamping apparatus 806. The method 800 may comprise providing an inert gas in the central space of each of the clamping elements during the laser welding. The inert supply gas may preferably be argon.

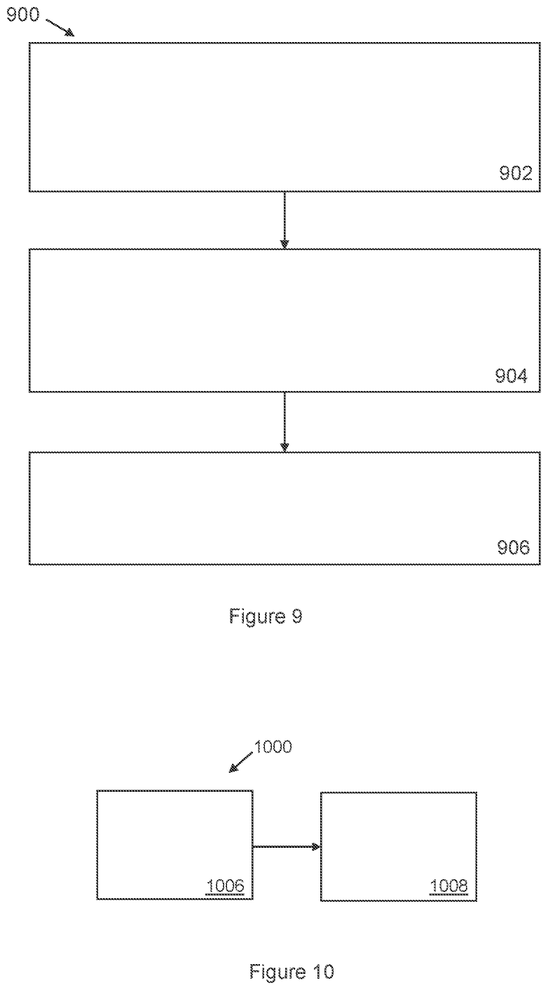

FIG. 9 shows a method 900 of laser welding a busbar assembly to a plurality of electrical cells. The method 900 comprises: locating the busbar assembly comprising a plurality of connection tabs on a welding face of the cell array, wherein each of the plurality of connection tabs is located on a corresponding terminal of a corresponding electrical cell 902; using any clamping apparatus disclosed herein to provide, via the plurality of clamping elements and corresponding spring elements, a compressive force to each connection tab and press the connection tab onto the corresponding terminal 904; and laser welding each connection tab to the corresponding terminal during the application of pressure by the clamping apparatus 906.

It will be understood that the order of the operations shown in FIGS. 8 and 9 is not essential, and that in some embodiments the steps may be reordered, and/or some steps may be omitted entirely.

FIG. 10 shows a control system 1006 of a laser welding assembly 1000. The control system 1006 comprises one or more controllers, and is configured to control a laser welding system 1008 to perform a welding process to laser weld a busbar assembly to a cell array comprising a plurality of electrical cells, for example by any of the methods or using any of the apparatus described above. The control system 1006 may locate the busbar assembly comprising a plurality of connection tabs on a welding face of the cell array, wherein each of the plurality of connection tabs is located on a corresponding terminal of a corresponding electrical cell; use any clamping apparatus disclosed herein to provide, via the plurality of clamping elements, a compressive force to each connection tab and press the connection tab onto the corresponding terminal; and laser weld each connection tab to the corresponding terminal during the application of pressure by the clamping apparatus. The control system 1006 may locate the busbar assembly comprising a plurality of connection tabs on a welding face of the cell array, wherein each of the plurality of connection tabs is located on a corresponding terminal of a corresponding electrical cell; use any clamping apparatus disclosed herein to provide, via the plurality of clamping elements and corresponding spring elements, a compressive force to each connection tab and press the connection tab onto the corresponding terminal; and laser weld each connection tab to the corresponding terminal during the application of pressure by the clamping apparatus.

It will be appreciated that certain embodiments disclosed herein can be realised in the form of hardware, software or a combination of hardware and software; for example software to control a control system to perform a method as discussed above. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments disclosed herein. Accordingly, embodiments provide a program comprising code for implementing a system or method as claimed in any preceding claim and a machine readable storage storing such a program. Still further, embodiments disclosed herein may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A clamping apparatus for use in a laser welding system, the clamping apparatus comprising:
a support part having a clamping face;
a plurality of clamping elements extending from the clamping face; and
a plurality of spring elements, wherein:
each of the plurality of clamping elements is mounted on a respective spring element of the plurality of spring elements;
each of the plurality of clamping elements is arranged to provide a compressive force to a respective connection tab of a busbar assembly when a compressive force is applied to the support part, to press each respective connection tab onto a corresponding terminal of an electrical cell of a cell array; and
each spring element is configured to compress when the compressive force is applied to the support part and when the corresponding clamping element mounted on the spring element contacts the respective connection tab to be laser welded.

2. The clamping apparatus of claim 1, wherein:
each clamping element comprises a mounting end located proximal to the spring element and a contact end configured to engage a connection tab to be laser welded; and
each clamping element and corresponding spring element comprise a central space from the mounting end to the contact end to allow passage of laser light therethrough to perform laser welding.

3. The clamping apparatus of claim 2, wherein each spring element comprises at least one spring finger portion extending inwardly towards the central space of the corresponding clamping element, and wherein each clamping element is mounted on the at least one spring finger portion of the corresponding spring element.

4. The clamping apparatus of claim 3, wherein each spring element comprises a plurality of spring finger portions and each clamping element is mounted on the plurality of spring finger portions of the corresponding spring element; preferably, wherein each clamping element is mounted on three spring finger portions of the corresponding spring element.

5. The clamping apparatus of claim 2, wherein:
each clamping element comprises a peripheral outer wall extending between the mounting end and the contact end; and
each spring element comprises:
a peripheral spring portion located around at least an outer portion of the peripheral outer wall at the mounting end of the corresponding clamping element; and
a corresponding spring finger portion extending from the peripheral spring portion inwardly towards the central space of the corresponding clamping element, wherein each clamping element is mounted on the spring finger portion of the corresponding spring element;
preferably, wherein each spring element comprises three peripheral spring portions and three corresponding spring finger portions.

6. The clamping apparatus of claim 2 wherein each clamping element is configured to rotate about a rotation axis oriented centrally through the central space.

7. The clamping apparatus of claim 1, wherein each spring element is configured to compress in a partial portion of the spring element when the compressive force is applied to the support part and when the corresponding clamping element mounted on the spring element contacts the respective connection tab to be laser welded, thereby allowing the corresponding clamping element to tilt with respect to the clamping face during clamping.

8. The clamping apparatus of claim 3, wherein:
the support part comprises a clamping plate comprising the clamping face, and a back plate parallel with the clamping plate; and
each spring element comprises a spring plate sandwiched between the clamping plate and the back plate to hold each spring element in the support part, and wherein each spring element extends from the spring plate.

9. The clamping apparatus of claim 8, wherein the clamping apparatus comprises one or more of:
a plurality of individual spring plates each corresponding to a respective clamping element of the plurality of clamping elements; and
a common spring plate comprising a plurality of spring elements corresponding to the plurality of clamping elements.

10. The clamping apparatus of claim 3, wherein:
the at least one spring finger portion comprises an elongated connection tab portion; and
the at least one spring finger portion is bent so that the elongated connection tab portion is in a different plane to the clamping face, toward the clamping face; and
the clamping element is mounted on the elongated connection tab portion.

11. The clamping apparatus of claim 9, wherein:
the at least one spring finger portion comprises an elongated connection tab portion and an end connection tab portion;
the at least one spring finger portion is bent so that the elongated connection tab portion and the clamping face are in substantially parallel planes; and
the clamping element is mounted on the end connection tab portion.

12. The clamping apparatus of claim 1, wherein each spring element is configured to provide, when compressed, a linear force towards the respective connection tab to be welded, of up to 4 N.

13. The clamping apparatus of claim 1, wherein each spring element is configured to allow a position of the corresponding clamping element with respect to the clamping face, when compressed, to move along a direction substantially perpendicular to the clamping face by up to 2.2 mm.

14. A method of laser welding a busbar assembly to a plurality of electrical cells, the method comprising:
locating the busbar assembly comprising a plurality of connection tabs on a welding face of the cell array, wherein each of the plurality of connection tabs is located on a corresponding terminal of a corresponding electrical cell;
using the clamping apparatus of claim 1 to provide, via the plurality of clamping elements and corresponding spring elements, a compressive force to each connection tab and press the connection tab onto the corresponding terminal; and
laser welding each connection tab to the corresponding terminal during application of pressure by the clamping apparatus.

15. A control system comprising one or more controllers, the control system configured to control a laser welding system to perform a welding process to laser weld a busbar assembly to a cell array comprising a plurality of electrical cells, by:
locating the busbar assembly comprising a plurality of connection tabs on a welding face of the cell array, wherein each of the plurality of connection tabs is located on a corresponding terminal of a corresponding electrical cell;
using the clamping apparatus of claim 1 to provide, via the plurality of clamping elements and corresponding spring elements, a compressive force to each connection tab and press the connection tab onto the corresponding terminal; and
laser welding each connection tab to the corresponding terminal during application of pressure by the clamping apparatus.

16. The clamping apparatus of claim 2, wherein each clamping element has one or more of:
an internal dimension across the mounting end through a central point of the mounting end face of between 10 mm and 15 mm; and
an internal dimension across the contact end through a central point of contact end face of between 5 mm and 9 mm.

17. The clamping apparatus of claim 2, wherein a distance between the mounting end and the contact end is between 14 mm and 21 mm.

18. The clamping apparatus of claim 2, wherein each clamping element is rotatably mounted on the clamping face of the support part to allow for rotation of the clamping element about a rotation axis substantially normal to the clamping face.

19. The clamping apparatus of claim 1, wherein the support part comprises between 20 and 100 clamping elements; optionally wherein the support part comprises between 40 and 80 clamping elements.

20. The clamping apparatus of claim 1, wherein the spring elements are made of steel.
